(19) United States
(12) Patent Application Publication
(10) Pub. No.: US 2016/0146326 A1
(43) Pub. Date: May 26, 2016

(54) DRIVE PLATE AND METHOD FOR MANUFACTURING THE SAME

(71) Applicant: AISIN AW CO., LTD., Aichi (JP)

(72) Inventors: Hiroshi SHIBATA, Takahama (JP); Gen HAMADA, Toyota (JP); Hiroki YOKOYAMA, Gamogori (JP); Tsuyoshi AOYAMA, Nagakute (JP); Yoshitomo IZAWA, Gamagori (JP); Takuya INAGAKI, Gamagori (JP); Shuji YAMAGUCHI, Gamagori (JP); Sachio HONJO, Anjo (JP); Tomoyuki HORI, Anjo (JP); Naoki YOKOYAMA, Nishio (JP); Ken SHIMIZU, Toyota (JP); Kenta ITAYAMA, Anjo (JP)

(73) Assignee: AISIN AW CO., LTD., Anjo-shi, Aichi-ken (JP)

(21) Appl. No.: 14/899,678

(22) PCT Filed: Jul. 11, 2014
(86) PCT No.: PCT/JP2014/068583

§ 371 Date: Dec. 18, 2015

(30) Foreign Application Priority Data
Jul. 12, 2013 (JP) 2013-146332

(51) Int. Cl. F16H 55/17; B21K 1/30

(52) U.S. Cl. CPC F16H 55/17; B21K 1/30

(57) ABSTRACT

A drive plate includes a plate section connected to a crankshaft of an engine, and an annular ring gear section that extends in an axial direction from an outer circumference of the plate section and includes external teeth that mesh with a pinion gear of a cell motor for cranking the engine, where the plate section and the ring gear section are integrally formed by press working; each of the inner side recesses is formed on an inner circumferential surface of the ring gear section so as to be located on an inner side of each of the external teeth at least on a play end side of the ring gear section; and each of the external teeth includes a step portion recessed toward the inner side than a tooth tip on the play end side.

### TECHNICAL FIELD

The present application relates to a drive plate for transmitting power from an engine to an object of power transmission, and a method for manufacturing the same.

### BACKGROUND ART

For this type of drive plate, a drive plate in which a plate section and a ring gear section are integrally formed by press working is conventionally known, the plate section being connected to a crankshaft of the engine and being connected to a torque converter, which is an object of power transmission, by way of a set block, and the ring gear section including a plurality of external teeth that meshes with a pinion gear of a motor for cranking the engine (see e.g., patent documents 1 and 2). The manufacturing cost can be greatly reduced in such a drive plate, for which a cutting step of the ring gear, a welding step of the plate and the ring gear, and the like are not necessary, as opposed to a drive plate including the plate and the ring gear, which are formed as separate bodies and coupled with a bolt, and the like.

A manufacturing device including a first constraining punch, a second constraining punch, a tooth profile punch, a compression punch, and a dice section is known for the manufacturing device of the integrated drive plate described above (see e.g., Patent Document 3). When manufacturing the integrated drive plate (tooth profile component) with such manufacturing device, a disc-shaped work made of metal is first disposed on the second constraining punch, and then the first constraining punch, the tooth profile punch, and the compression punch are moved forward with respect to the second constraining punch and the dice section with the second constraining punch fixed (work arranging step). Next, the first constraining punch, the tooth profile punch, and the compression punch are further moved forward with respect to the second constraining punch with the second constraining punch fixed to form a step shape in the work (step forming step).

Then, a state in which the work is sandwiched and constrained by the first constraining punch, the second constraining punch, and the tooth profile punch is maintained, and the first constraining punch, the second constraining punch, the tooth profile punch, and the compression punch are moved forward with respect to the dice section (draw forming step). The draw forming process is thereby performed on the work by the tooth profile punch and the dice section (draw forming die). Furthermore, the first constraining punch, the second constraining punch, the tooth profile punch, and the compression punch are moved forward with respect to the dice section while maintaining a state in which the work is sandwiched and constrained by the first constraining punch, the second constraining punch, and the tooth profile punch (diameter-reduced tooth profile forming step). The diameter reduction forming process is thereby performed on the work by the tooth profile punch and the dice section (diameter reduction die).

The compression punch is then moved forward with respect to the dice section while maintaining a state in which the work is sandwiched and constrained by the first constraining punch, the second constraining punch, and the tooth profile punch (thickened tooth profile forming step). A diameter-reduced side wall portion of the work is thereby compressed by the compression punch, and the thickened tooth profile shape is formed. The first constraining punch, the second constraining punch, the tooth profile punch, and the compression punch are then moved backward from the dice section, the first constraining punch, the tooth profile punch, and the compression punch are moved backward from the second constraining punch, and a molded article (drive plate) is taken out from the manufacturing device (delivering step).

Furthermore, as a method for manufacturing the integrated drive plate, a method of placing the constraining punch on the back side (inner diameter side) of the tooth profile forming surface of the side wall portion formed in advance to regulate (constrain) the movement of the material, applying a forging load to the upper end face of the side wall portion in this state with a forging punch, and actively buckling the side wall portion is known (see e.g., patent document 4). The constraining punch used in this manufacturing method includes a plurality of projections, and the vicinity of the middle in the axial direction of the side wall portion of the ring gear is bulged out toward the die on the outer side by the presence of the projections. Thus, in the tooth profile forming (thickening) of the ring gear section, a void (recess) is formed in the vicinity of the middle in the axial direction of the side wall portion of the ring gear so as to be located on the inner side (back side) of each external tooth and the forging load at the time of the tooth profile forming need not be increased as the closed forging can be avoided by the presence of the void.

### RELATED-ART DOCUMENTS

### Patent Documents

[Patent Document 1] Japanese Patent Application Publication No. H10-132052 (JP H10-132052 A)

[Patent Document 2] Japanese Patent Application Publication No. 2007-170596 (JP 2007-170596 A)

[Patent Document 3] Japanese Patent Application Publication No. 2012-200749 (JP 2012-200749 A)

[Patent Document 4] Japanese Patent Application Publication No. H07-256377 (JP H07-256377 A)

### SUMMARY

In the drive plate integrally formed by press working as described above, a seam (wrinkle portion) is generally formed on the inner side of each external tooth as the materials flowing in from both sides are brought into contact. However, at the seam formed on the inner side of each external tooth, the materials that flowed in from both sides are not completely joined (fused) with each other, and the strength around the seam cannot be easily enhanced. Therefore, the integrally formed drive plate still needs improvements in durability.

It is a main object of the present disclosure to further enhance the durability of the drive plate integrally formed by press working.

The drive plate and the method for manufacturing the same of the present disclosure adopt the following means to achieve the above main object.

A drive plate of the present disclosure relates to a drive plate for transmitting power from an engine to an object of power transmission, the drive plate including a plate section connected to a crankshaft of the engine, and an annular ring gear section that extends in an axial direction from an outer circumference of the plate section and includes a plurality of external teeth that meshes with a drive gear of a motor for cranking the engine; wherein the plate section and the ring gear section are integrally formed by press working; each of a plurality of inner side recesses is formed on an inner circumferential surface of the ring gear section so as to be located on an inner side of each of the plurality of external teeth at least on a play end side of the ring gear section; and each of the plurality of external teeth includes a step portion recessed toward the inner side than a tooth tip on the play end side.

The drive plate includes the plate section and the ring gear section integrally formed by press working. In such drive plate, generally, the seam (wrinkle portion) is formed on the inner side of each external tooth of the ring gear section when the materials flowing in from both sides are brought into contact, but as a result of researches and analyses conducted by the inventors of the present disclosure, it became apparent that the stress generated at the seam located on the inner side of each external tooth increased on the play end side compared with the base end side of the ring gear section in the annular ring gear section extending in a cantilever form from the outer circumference of the plate section. In view of the results of such researches and analyses, each of a plurality of inner side recesses is formed on the inner circumferential surface of the ring gear section of the drive plate so as to be located on the inner side of each of the plurality of external teeth at least on the play end side of the ring gear section, and a step portion recessed toward the inner side than the tooth tip on the play end side is formed in each of the plurality of external teeth. Thus, the seam (wrinkle portion) is prevented from being formed when the materials flow in from both sides upon thickening the external tooth, in particular, on the inner circumferential surface on the play end side of the ring gear section, and the occurrence of stress concentration on the play end side of the ring gear section can be suppressed by forming the inner side recess and the step portion on each external tooth and suppressing the thickness in the radial direction on the play end side of each external tooth. As a result, in the drive plate, the strength of the ring gear section integrally formed with the plate section by press working can be satisfactorily ensured and the durability can be enhanced.

A portion of an end face on the play end side of the external tooth toward the tooth tip with respect to the step portion may be depressed in the axial direction toward a base end side of the ring gear section.

Furthermore, the inner side recess may extend from the play end to a surface of the plate section on the play end side. Thus, the amount of material required to form the drive plate may be reduced, that is, the size (outer diameter) of the drive plate formed from the material of the same dimension and the axial length of the ring gear section can be further increased by forming the plurality of inner side recesses over substantially entirely in the axial direction of the inner circumferential surface of the ring gear section.

The inner side recess may be formed to be located at least on the inner side of the step portion and so as not to reach the surface of the plate section on the play end side. Thus, the strength of the dedendum at the base end side (plate section side) of each external tooth and furthermore, the strength of the entire ring gear section can be enhanced by not forming the inner side recess on the base end side (plate section side) of the inner circumferential surface of the ring gear section.

Furthermore, the step portion may be located on the play end side of a meshing portion of a tooth of the drive gear and the external tooth at which the drive gear meshes with the external tooth without projecting out from the play end of the ring gear section. Thus, the meshing width of the tooth of the drive gear and the external tooth of the ring gear section can be satisfactorily ensured, and the degradation of the sound quality and the sound pressure of the gear noise caused by cranking the engine with the motor can be suppressed. If the step portion of each external tooth is formed to be located on the play end side of the meshing portion of the tooth of the drive gear and the external tooth at which the drive gear meshes with the external tooth without projecting out from the play end of the ring gear section, the meshing width of the tooth of the drive gear and the external tooth of the ring gear section can be satisfactorily ensured even if the drive gear projects out from the play end of the ring gear section due to the manufacturing variation, and the like.

A method for manufacturing a drive plate according to the present disclosure relates to a method for manufacturing a drive plate in which a plate section connected to a crankshaft of an engine and an annular ring gear section that extends in an axial direction from an outer circumference of the plate section and includes a plurality of external teeth that meshes with a drive gear of a motor for cranking the engine, are integrally formed by press working, wherein each of a plurality of inner side is formed on an inner circumferential surface of the ring gear section so as to be located on an inner side of each of the plurality of external teeth at least on a play end side of the ring gear section, and a step portion recessed toward an inner side than a tooth tip on the play end side is formed in each of the plurality of external teeth.

According to such method, the durability of the drive plate integrally formed by the press working can be further enhanced.

The manufacturing method may include a step of compressing an annular wall portion formed in a work using a compression punch, with a constraining punch disposed on an inner side of the annular wall portion and a dice section disposed on an outer side of the annular wall portion; wherein the constraining punch may include a plurality of projections that projects out in a radial direction on at least a play end side of the annular wall portion; and the compression punch may include a plurality of protrusions that projects out toward the dice section. Thus, when moving the compression punch with respect to the constraining punch and the dice section and thickening the external tooth of the annular wall portion (ring gear section), the movement of the material can be regulated by the plurality of projections of the constraining punch to form the plurality of inner side recesses of the ring gear section and the movement of the material can be regulated by the plurality of protrusions of the compression punch to form the step portion of each external tooth.

### BRIEF DESCRIPTION OF THE DRAWINGS

FIG. 1 is a plan view showing a drive plate according to one embodiment of the present disclosure

FIG. 2 is a cross-sectional view taken along line II-II of FIG. 1.

FIG. 3 is a cross-sectional view showing a forming die used to manufacture the drive plate according to the present disclosure.

FIG. 4 is an enlarged perspective view showing a third constraining punch configuring the forming die.

FIG. 5 is an enlarged perspective view showing a compression punch configuring the forming die.

FIG. 6 is an enlarged partial cross-sectional view of a main part showing a drive plate according to a comparative example.

FIG. 7 is a chart showing a relationship of a distance from a play end of the ring gear section and a stress generated on an inner circumferential portion of the ring gear section in the drive plate according to the present disclosure and the comparative example.

FIG. 8 is an enlarged cross-sectional view showing a state of manufacturing the drive plate according to the present disclosure.

FIG. 9 is an enlarged perspective view of a main part showing the drive plate according to the present disclosure.

FIG. 10 is an enlarged cross-sectional view of a main part showing the drive plate according to the present disclosure.

FIG. 11 is an enlarged partial cross-sectional view of a main part showing the drive plate according to the present disclosure.

FIG. 12 is an enlarged cross-sectional view of a main part showing a drive plate according to a modification of the embodiment of the present disclosure.

### DETAILED DESCRIPTION OF THE PREFERRED EMBODIMENT

A mode for carrying out the present disclosure will now be described with reference to the drawings.

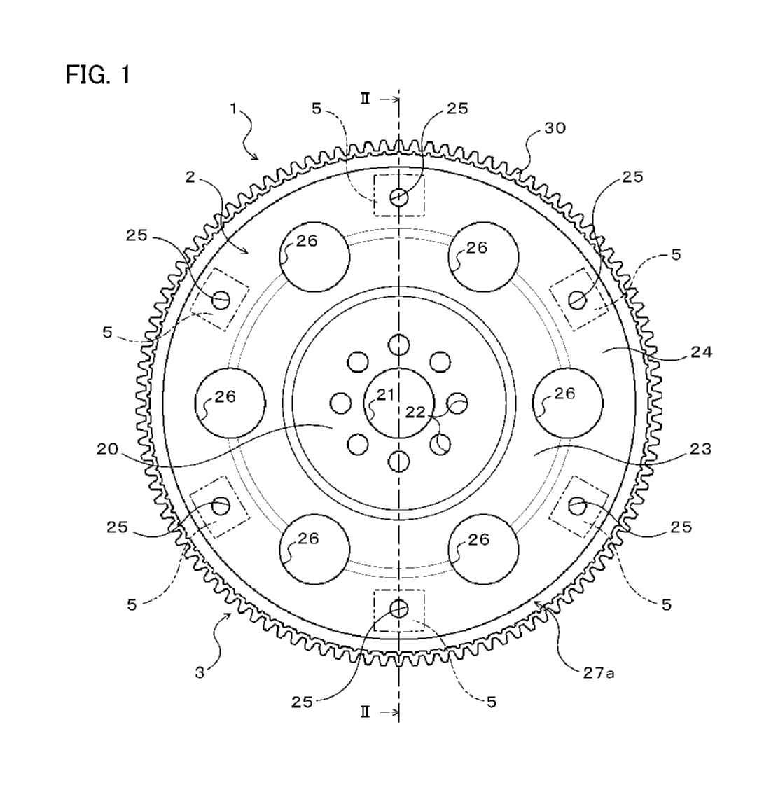

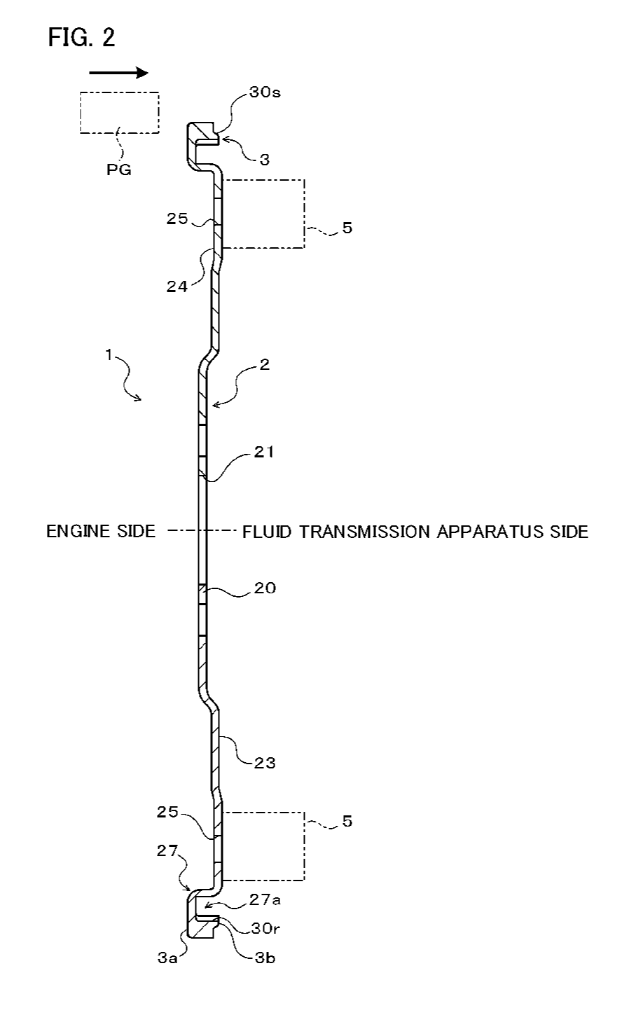

FIG. 1 is a plan view showing a drive plate 1 according to one embodiment of the present disclosure, and FIG. 2 is a cross-sectional view taken along line II-II of FIG. 1. The drive plate 1 shown in the figures is used to transmit power output from an engine (internal combustion engine) (not shown), which serves as a motor mounted on a vehicle, to a fluid transmission apparatus (not shown) such as a torque converter or a fluid joint, which serves as an object of power transmission . As shown in the figure, the drive plate 1 includes a plate section 2 connected to a crankshaft of the engine and the fluid transmission apparatus, and an annular ring gear section 3 that can mesh with a pinion gear (drive gear) PG (see FIG. 2) of a cell motor (not shown) for cranking the engine. The drive plate 1, that is, the plate section 2 and the ring gear section 3 are integrally formed, for example, by press working a plate material (metal plate) having flexibility such as cold rolled steel plate.

As shown in the figure, the plate section 2 of the drive plate 1 includes a flat annular first coupling portion 20 formed at a center portion. The first coupling portion 20 includes a center hole 21 formed so as to be located at the center thereof, and a plurality of (eight in the present embodiment) first coupling holes 22 is disposed at equal intervals at the circumference of the center hole 21. An annular flat portion 23 is formed at the circumference of the first coupling portion 20 so as to project out toward the fluid transmission apparatus from the first coupling portion 20, and a flat annular second coupling portion 24 is formed at the circumference of the flat portion 23 so as to project out slightly toward the fluid transmission apparatus from the flat portion 23. A plurality of (six in the present embodiment) second coupling holes 25 is formed at equal intervals in the second coupling portion 24, where the second coupling portion 24 has a flat contacting surface, which makes contact with a set block welded to a front cover, of the fluid transmission apparatus, for example, at a circumference of each second coupling hole 25, as shown in FIGS. 1 and 2.

The plate section 2 also includes a plurality of (six in the present embodiment) lightening holes 26 formed at equal intervals. In the present embodiment, the lightening hole 26 is a circular hole, and is disposed between the second coupling holes 25 adjacent to each other so as to extend across the flat portion 23 and the second coupling portion 24. Furthermore, the plate section 2 includes an annular drawing portion 27 formed to surround the circumference of the second coupling portion 24. In the present embodiment, the drawing portion 27 is formed so that an annular recess 27a opens toward the fluid transmission apparatus.

The crankshaft of the engine and the first coupling portion 20 of the plate section 2 are fastened by a bolt inserted to each first coupling hole 22 so that the recess 27a of the drawing portion 27 is located on the fluid transmission apparatus side. The set block 5 fixed to the fluid transmission apparatus is brought into contact with the contacting surface on the recess 27a side of the second coupling portion 24 and is fastened to the plate section 2 by a bolt inserted to each second coupling hole 25. The engine and the fluid transmission apparatus are thereby coupled by way of the drive plate 1, and the power output from the engine can be transmitted to the fluid transmission apparatus, which is the object of power transmission.

The ring gear section 3 extends in a cantilever form in the axial direction of the drive plate 1 from the outer circumference of the plate section 2 and is formed so as to surround the recess 27a of the drawing portion 27, and includes a plurality of external tooth 30, each including, for example, a tooth surface formed of an involute curve and a generally flat tooth tip surface, and capable of meshing with the teeth of the pinion gear PG of the cell motor. In the present embodiment, each tooth of the pinion gear PG has a tooth trace extending parallel to an axis center, and the pinion gear PG is connected to a rotor of the cell motor (not shown) and moved toward the drive plate 1 (fluid transmission apparatus side) from the engine side, as shown in FIG. 2, at the start of the engine. Each tooth of the pinion gear PG then enters between the adjacent external teeth 30 from one end in a tooth width direction of the ring gear section 3, that is, a base end 3a on the engine side (jumping side). A distal end (end on fluid transmission apparatus side) of the pinion gear PG is, basically, located on the base end 3a side rather than the other end of the ring gear section 3, that is, a play end 3b on the fluid transmission apparatus side (anti-jumping side), but may project out toward the fluid transmission apparatus from the play end 3b depending on the manufacturing variation, and the like.

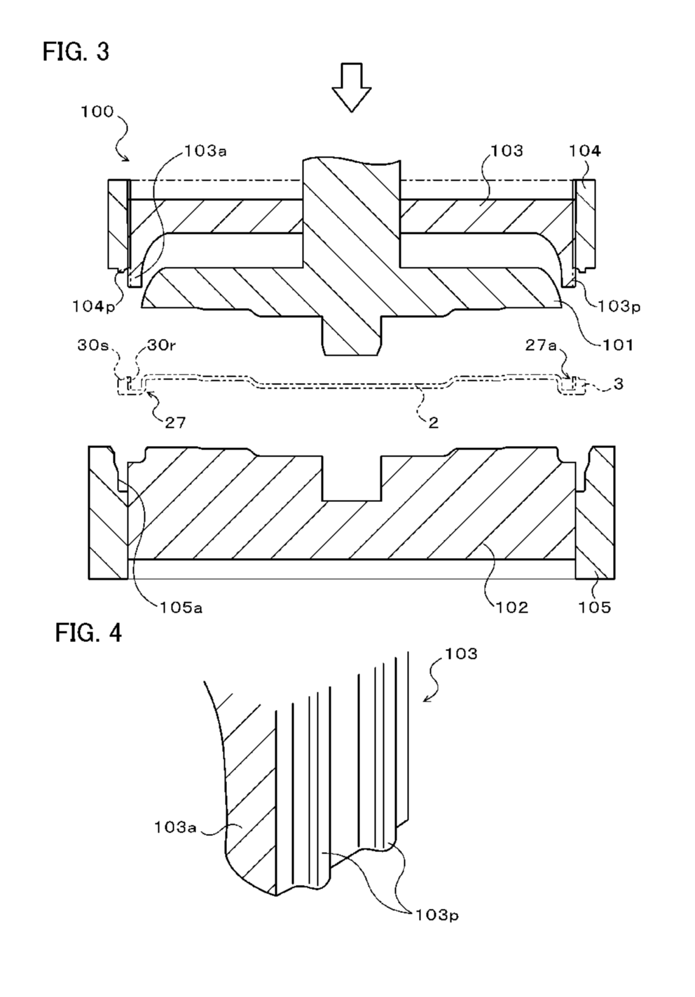

The drive plate 1 described above is manufactured using a forming die 100 including a first constraining punch 101, a second constraining punch 102, a third constraining punch 103, a compression punch 104, and a dice section 105 shown in FIG. 3.

The first constraining punch 101 is formed into a generally disc shape, and is disposed on the upper side in the figure of the second constraining punch 102 so as to be able to move closer to or away from the second constraining punch 102. A surface facing the second constraining punch 102 of the first constraining punch 101 is shaped to be projected and recessed for forming the first coupling portion 20, the flat portion 23, and the second coupling portion 24 of the plate section 2. The second constraining punch 102 is formed into a generally circular column shape, and is disposed in the dice section 105 so as to be movable with the first constraining punch 101 in a vertical direction in FIG. 3 with respect to the dice section 105. A surface facing the first constraining punch 101 of the second constraining punch 102 is also shaped to be projected and recessed for forming the first coupling portion 20, the flat portion 23, the second coupling portion 24 and the drawing portion 27 of the plate section 2.

The third constraining punch 103 includes an annular forming portion 103a that surrounds the outer circumference of the first constraining punch 101 and that faces the outer circumferential portion (recess for forming the drawing portion 27) of the second constraining punch 102, and is disposed on an upper side in the figure of the first constraining punch 101 so as to be movable in the vertical direction in FIG. 3 with respect to the first constraining punch 101 and to be movable with the first and second constraining punches in the vertical direction in FIG. 3 with respect to the dice section 105. As shown in FIG. 4, a projection 103p of a number (plurals) corresponding to the number of teeth of the ring gear section 3 of the drive plate 1 is formed on the outer circumferential surface of the annular forming portion 103a of the third constraining punch 103 so as to project out in the radial direction and to extend along the vertical direction in the figure, that is, the moving direction (axial direction of the ring gear section 3) of the third constraining punch 103. In the present embodiment, the length in the vertical direction in the figure of each projection 103p is set to be longer than the depth of the recess 27a of the drive plate 1.

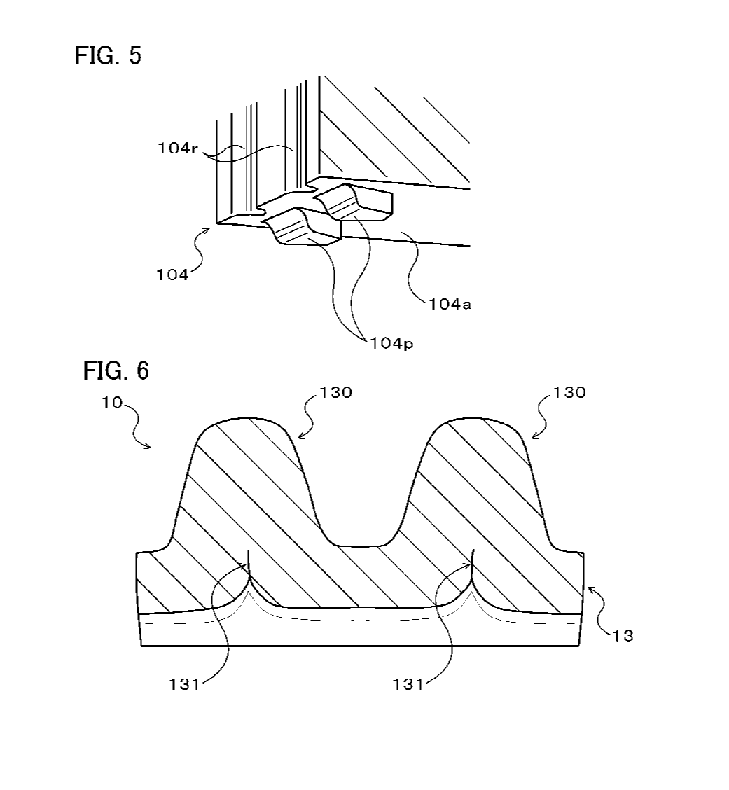

The compression punch 104 is formed into a generally annular shape, and is disposed to surround the third constraining punch 103 so as to be movable in the vertical direction in FIG. 3 with respect to the third constraining punch 103, and the like. As shown in FIG. 5, a plurality of recesses 104r that respectively engages the projections 103p formed on the annular forming portion 103a of the third constraining punch 103 is formed on the inner circumferential surface of the compression punch 104. Furthermore, the compression punch 104 includes a flat distal end face 104a (lower end face in FIGS. 3 and 5) facing the dice section 105, and protrusions 104p of a number (plurals) corresponding to the number of teeth of the ring gear section 3 projecting out toward the dice section 105 (axial direction of ring gear section 3) from the distal end face 104a. The plurality of protrusions 104p is formed to face the corresponding projections 103p of the third constraining punch 103 with a clearance in the radial direction of the forming die 100. A height (length in the vertical direction in FIGS. 3 and 5) from the distal end face 104a of each protrusion 104p is set to be, for example, about 10 to 40%, more preferably, about 10 to 20% of the axial length (tooth width of external tooth 30) of the ring gear section 3 according to the size, and the like of the drive plate 1.

The dice section 105 is formed into a generally annular shape, and is disposed so as to surround the second constraining punch 102. An inner circumferential surface 105a of the dice section 105 includes a draw forming portion located on the first constraining punch 101 side, that is, the upper side in FIG. 3, and a diameter-reduced tooth profile forming portion located on a lower side in FIG. 3 than the draw forming portion. A tooth profile for forming a plurality of external teeth 30 of the ring gear section 3 is provided on the inner circumferential surface 105a of the dice section 105.

When manufacturing the integrated drive plate 1 using the forming die 100 described above, a disc-shaped work made from a cold rolled steel plate, and the like, for example, is first disposed on the second constraining punch 102, and the first constraining punch 101 and the third constraining punch 103 are moved toward the second constraining punch 102 and the dice section 105 (lower side in FIG. 3) with the second constraining punch 102 fixed with respect to the dice section 105. Then, with the second constraining punch 102 fixed with respect to the dice section 105, the first constraining punch 101, the third constraining punch 103, and the compression punch 104 are further moved toward the second constraining punch 102 to apply a press load on the work. The step shape corresponding to the first coupling portion 20, the flat portion 23, and the second coupling portion 24 of the plate section 2 is thereby formed in the work.

Then, the state in which the work is sandwiched and constrained by the first constraining punch 101, the second constraining punch 102, and the third constraining punch 103 is maintained, and the first constraining punch 101, the second constraining punch 102, the third constraining punch 103, and the compression punch 104 are moved with respect to the dice section 105 to apply the press load on the work (diameter reduction forming step). The draw forming process is thereby performed on the outer circumferential portion of the work by the third constraining punch 103 and the draw forming portion of the dice section 105, and the drawing portion 27 (27a) and the ring gear section 3 start to be formed. Furthermore, when the first constraining punch 101, the second constraining punch 102, the third constraining punch 103, and the compression punch 104 are moved with respect to the dice section 105 to apply the press load on the work with the work sandwiched and constrained by the first constraining punch 101, the second constraining punch 102, and the third constraining punch 103, the diameter of the annular wall portion formed at the outermost circumference of the work is reduced and the tooth profile is formed by the third constraining punch 103 and the diameter reduction forming portion of the dice section 105.

Next, only the compression punch 104 is moved (moved forward) with respect to the dice section 105 to apply the press load on the work (thickened tooth profile forming step) with the work sandwiched and constrained by the first constraining punch 101, the second constraining punch 102, and the third constraining punch 103. Thus, the annular wall portion of the work is compressed by the compression punch 104, and a plurality of teeth (external tooth 30) with increased thickness is formed on the annular wall portion. The first constraining punch 101, the second constraining punch 102, the third constraining punch 103, and the compression punch 104, are separated (moved backward) from the dice section 105 and the first constraining punch 101, the third constraining punch 103, and the compression punch 104 are separated (moved backward) from the second constraining punch 102 to taken out the molded article (drive plate 1) from the forming die 100. The constraining of the work by the first to third constraining punches 101 to 103 may be released at the stage where the diameter reduction forming step is completed, and the thickened tooth profile forming step may be executed (in a separate step) using other compression punches, dices, and the like.

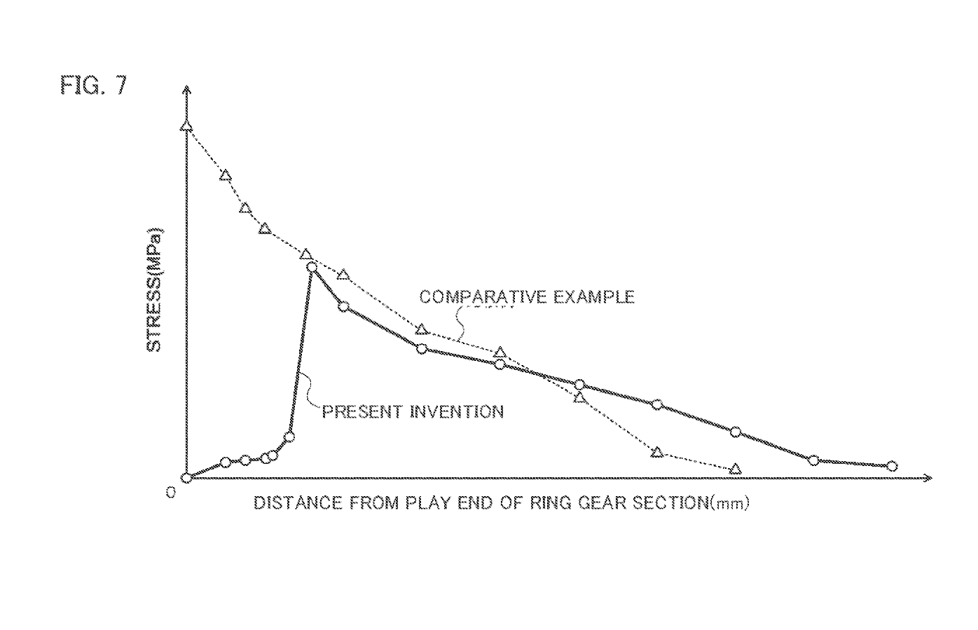

As shown in FIG. 6, in the drive plate 10 serving as a general comparative example integrally formed by the press working, as described above, a seam (wrinkle portion) 131 is formed when the materials flowing in from both sides make contact with each other on the inner circumferential surface of the ring gear section 3, that is, the inner side of each external tooth 130. At the seam 131 thus formed on the inner side of each external tooth 130, the materials flowing in from both sides are not completely joined (fused), and hence it is not easy to enhance the strength around the seam 131. As a result of researches/analyses conducted by the inventors of the present disclosure, it became apparent that if the annular ring gear section 3 is extended in a cantilever form from the outer circumference of the plate section (not shown in FIG. 6), the stress generated at the seam 131 located on the inner side of each external tooth 130 increases on the play end side compared to the base end side of the ring gear section 3, as shown by a dotted line in FIG. 7.

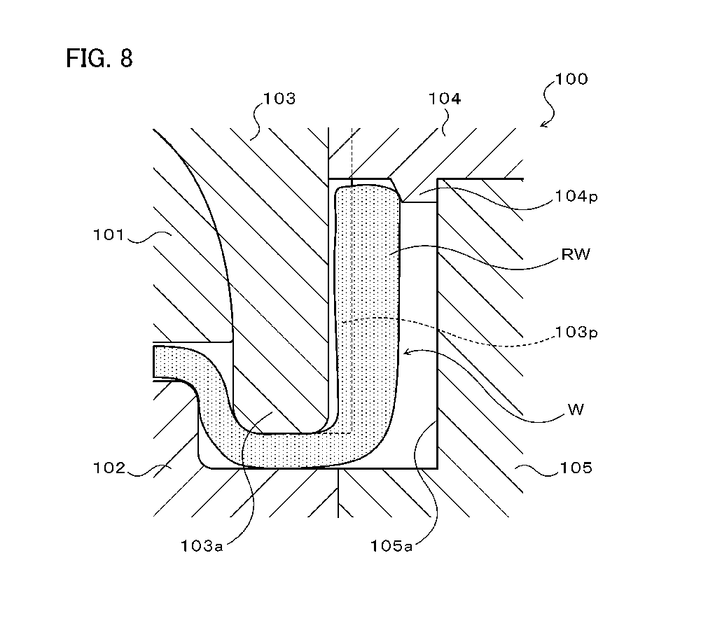

In view of the results of such researches/analyses, a plurality of projections 103p projecting out in the radial direction is formed on the third constraining punch 103 of the forming die 100 used for the manufacturing of the drive plate 1, and a plurality of protrusions 104p is formed to project out from the distal end face 104a toward the dice section 105 (axial direction of ring gear section 3) on the compression punch 104. As shown in FIG. 8, when moving the compression punch 104 with respect to the third constraining punch 103 and the dice section 105 to compress the annular wall portion RW, that is, when moving the compression punch 104 with respect to the third constraining punch 103 and the dice section 105 to thicken the external tooth of the annular wall portion RW (ring gear section) with the third constraining punch 103 disposed on the inner side of the annular wall portion RW formed in the work W and the dice section 105 disposed on the outer side of the annular wall portion RW, the movement of the material is regulated by the plurality of projections 103p of the third constraining punch 103 and the plurality of protrusions 104p of the compression punch 104. That is, when thickening the external tooth, the flowing in of the material from both sides to between each projection 103p of the third constraining punch 103 and each protrusion 104p of the compression punch 104 is suppressed.

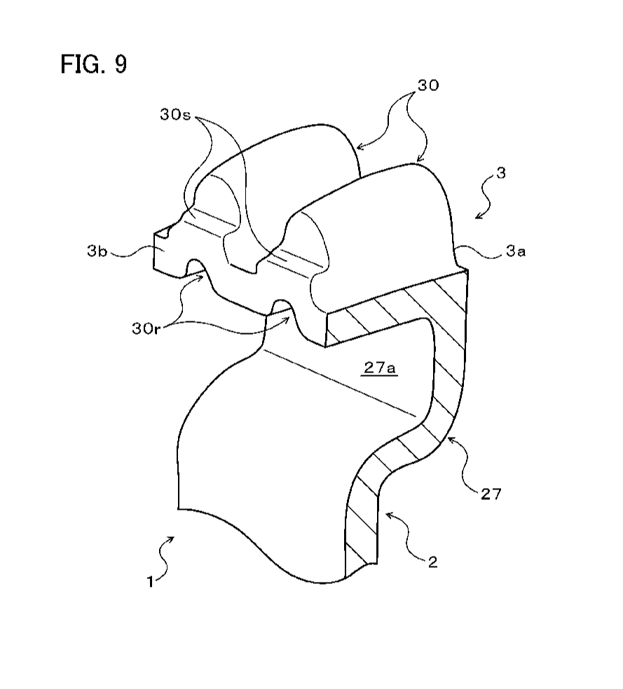

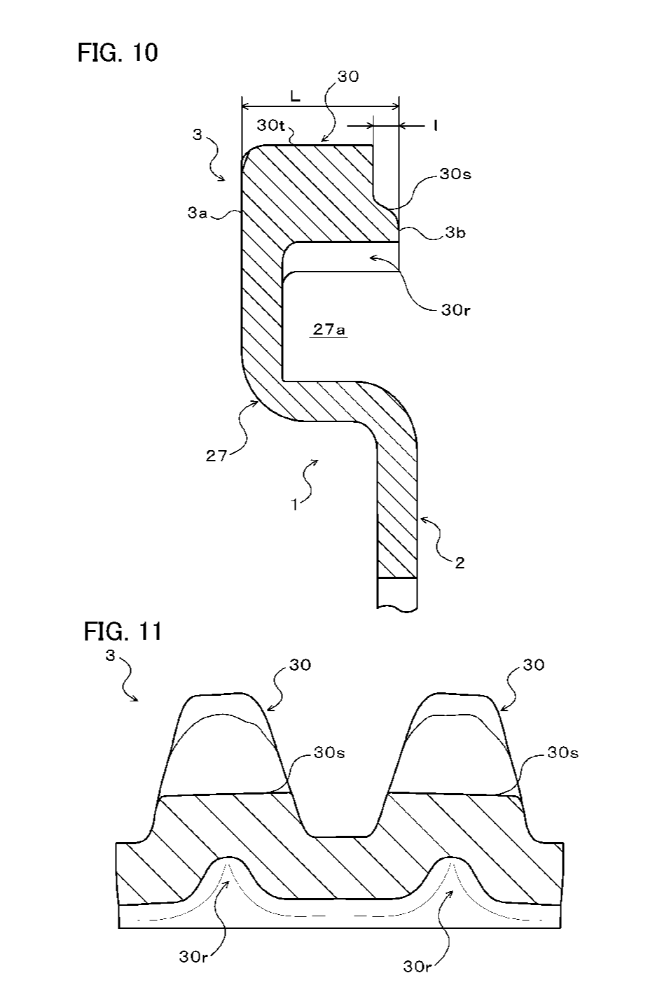

As a result, as shown in FIGS. 9 to 11, each of a plurality of inner side recesses 30r located on the inner side of each of the plurality of external teeth 30 and extended from the play end 3b to the bottom surface of the recess 27a, that is, the surface of the plate section 2 on the play end 3b side is formed on the inner circumferential surface of the ring gear section 3 of the drive plate 1 manufactured using the forming die 100. Furthermore, in each of the plurality of external teeth 30 of the ring gear section 3, a step portion (outer side recess) 30s recessed in a range between the play end 3b and the position spaced apart toward the basal end 3a side from the play end 3b by distance 1, that is, toward the inner side (axis center side) from the tooth tip 30t (see FIG. 10) on the play end 3b side is formed. Thus, the portion of the end face on the play end 3b side of the external tooth 30 toward the tooth tip 30t with respect to the step portion 30s is depressed in the axial direction of the ring gear section 3 (drive plate 1) toward the base end 3a side of the ring gear section 3.

The inner side recess 30r and the step portion 30s are formed on each external tooth 30 to suppress the thickness in the radial direction on the play end 3b side of each external tooth 30, so that the seam (wrinkle portion) that forms when the material flows in from both sides upon thickening the external tooth, in particular, does not form on the inner circumferential surface on the play end 3b side of the ring gear section 3, as shown in FIG. 11. As shown by a solid line in FIG. 7, the stress generated on the inner side of each external tooth 30 is satisfactorily reduced on the play end 3b side of the ring gear section 3, and the stress generated on the inner side of each external tooth 30 can be made to smaller than or equal to a sufficiently low allowable stress predetermined for the entire ring gear section 3 by forming the inner side recess 30r and the step portion 30s on each external tooth 30. As a result, in the drive plate 1, the occurrence of stress concentration on the play end 3b side of the ring gear section 3 can be satisfactorily suppressed, and the strength of the ring gear section 3 integrally formed with the plate section 2 by the press working can be satisfactorily ensured and the durability can be enhanced.

In addition, in the drive plate 1, the plurality of inner side recesses 30r is formed from the play end 3b to the bottom surface of the recess 27a (surface of plate section 2 on the play end 3b side), that is, over substantially entirely in the axial direction of the inner circumferential surface of the ring gear section 3. Thus, the amount of material required to form the drive plate 1 can be reduced, that is, the size (outer diameter) of the drive plate 1 formed from the material of the same dimension and the axial length of the ring gear section 3 can be increased.

Each protrusion 104p of the compression punch 104 used for the manufacturing of the drive plate 1 is formed to have a length of, for example, about 10 to 40% (more preferably 10 to 20%) of the axial length L (tooth width of the external tooth 30, see FIG. 10) of the ring gear section 3. Therefore, the length l from the play end 3b of each step portion 30s in the axial direction of the ring gear section 3 also becomes about 10 to 40% (more preferably 10 to 20%) of the axial length L (tooth width of the external tooth 30) of the ring gear section 3, and each step portion 30s is basically located on the play end 3b side of the meshing portion (meshing surface) of the tooth of pinion gear PG and the external tooth 30 at which the pinion gear PG meshes with the external teeth 30 without projecting out from the play end 3b of the ring gear section 3.

The meshing width of the tooth of the pinon gear PG and the external tooth 30 of the ring gear section 3 is thereby satisfactorily ensured, and the degradation in the sound quality and the sound pressure of the gear noise caused by cranking the engine with the cell motor can be suppressed. The meshing width of the tooth of the pinion gear PG and the external tooth 30 of the ring gear section 3 can be satisfactorily ensured even if the pinon gear PG projects out from the play end 3b of the ring gear section 3 due to the manufacturing variation, and the like by forming the step portion 30s of each external tooth 30 so as to be located on the play end 3b side of the meshing portion of the pinon gear PG and the external tooth 30 at which the pinion gear PG meshes with the external tooth 30 without projecting out from the play end 3b of the ring gear section 3 as described above.

As described up to now, in the drive plate 1 in which the plate section 2 and the ring gear section 3 are integrally formed by press working, each of the plurality of inner side recesses 30r is formed on the inner circumferential surface of the ring gear section 3 so as to be located on the inner side of each of the plurality of external teeth 30 at least on the play end 3b side of the ring gear section 3, where each of the plurality of external teeth 30 has a step portion 30s recessed toward the inner side than the tooth tip 30t on the play end 3b side. The seam (wrinkle portion) that forms when the material flows in from both sides when thickening the external tooth, in particular, is prevented from being formed on the inner circumferential surface on the play end 3b side of the ring gear section 3, and the occurrence of stress concentration on the play end 3b side of the ring gear section 3 can be suppressed by forming the inner side recess 30r and the step portion 30s on each external tooth 30 and suppressing the thickness in the radial direction on the play end 3b side of each external tooth 30. Therefore, in the drive plate 1, the strength of the ring gear section 3 integrally formed with the plate section 2 by press working can be satisfactorily ensured and the durability can be enhanced.

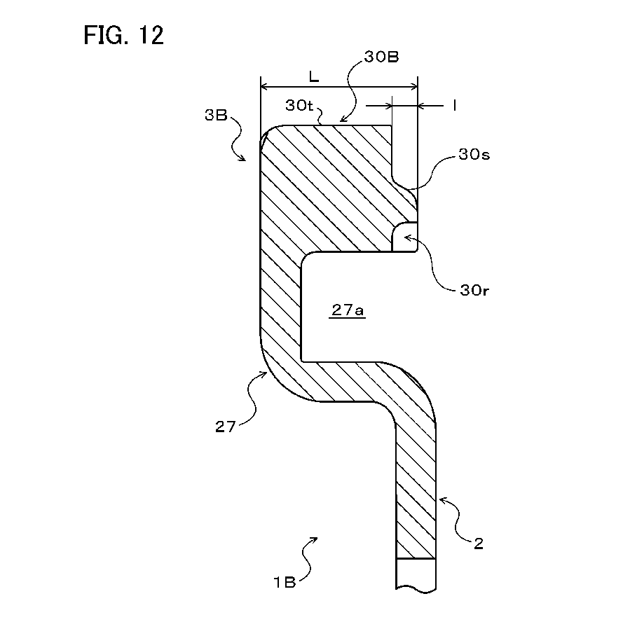

As apparent from the analysis result shown by a dotted line in FIG. 7, the stress generated at the seam located on the inner side of each external tooth becomes smaller the farther away from the play end of the ring gear section, and thus the strength of the ring gear section 3 can be satisfactorily ensured even if the seam exists on the inner circumferential surface on the basal end side of the ring gear section. Therefore, the plurality of inner side recesses 30r need not necessarily formed over substantially entirely in the axial direction of the inner circumferential surface of the ring gear section 3. In other words, the inner side recess 30r may be located at least on the inner side (axis center side of ring gear section 3B) of the step portion 30s of each external tooth 30B and formed on the inner circumferential surface of the ring gear section 3B so as not to reach the surface (bottom surface of recess 27a) on the play end side of the plate section 2 as in the drive plate 1B shown in FIG. 12. Thus, the strength of the dedendum on the base end 3a side (plate section 2 side) of each external tooth 30B and furthermore, the strength of the entire ring gear section 3B can be enhanced by preventing the inner side recess 30r from being formed on the base end 3a side of the inner circumferential surface of the ring gear section 3B, that is, the bottom surface side (plate section 2 side) of the recess 27a. When configuring the inner side recess 30r as shown in FIG. 12, a plurality of projections may be formed so as to project out in the radial direction only on the play end side of the annular wall portion RW shown in FIG. 8 with respect to the third constraining punch 103.

The embodiment of the present disclosure has been described above, but the present disclosure is not limited in any way to such embodiment, and various modifications can be made within an extensive scope of the present disclosure. The mode for carrying out the disclosure is merely one specific mode described in the SUMMARY, and should not limit the elements of the disclosure described in the SUMMARY.

### INDUSTRIAL APPLICABILITY

The present disclosure can be used, for example, in a manufacturing industry of a drive plate that transmits power from the engine to the object of power transmission.

1.-7 (canceled)

8. A drive plate for transmitting power from an engine to an object of power transmission, the drive plate comprising
a plate section connected to a crankshaft of the engine, and
an annular ring gear section that extends in an axial direction from an outer circumference of the plate section and includes a plurality of external teeth that meshes with a drive gear of a motor for cranking the engine; wherein
the plate section and the ring gear section are integrally formed by press working;
each of a plurality of inner side recesses is formed on an inner circumferential surface of the ring gear section so as to be located on an inner side of each of the plurality of external teeth at least on a play end side of the ring gear section; and
each of the plurality of external teeth includes a step portion recessed toward the inner side than a tooth tip on the play end side.

9. The drive plate according to claim 8, wherein
a portion of an end face on the play end side of the external tooth toward the tooth tip with respect to the step portion is depressed in the axial direction toward a base end side of the ring gear section.

10. The drive plate according to claim 8, wherein
the inner side recess extends from the play end to a surface of the plate section on the play end side.

11. The drive plate according to claim 8, wherein
the inner side recess is formed to be located at least on the inner side of the step portion and so as not to reach a surface of the plate section on the play end side.

12. The drive plate according to claim 8, wherein
the step portion is located on the play end side of a meshing portion of a tooth of the drive gear and the external tooth at which the drive gear meshes with the external tooth without projecting out from the play end of the ring gear section.

13. The drive plate according to claim 9, wherein
the step portion is located on the play end side of a meshing portion of a tooth of the drive gear and the external tooth at which the drive gear meshes with the external tooth without projecting out from the play end of the ring gear section.

14. The drive plate according to claim 10, wherein
the step portion is located on the play end side of a meshing portion of a tooth of the drive gear and the external tooth at which the drive gear meshes with the external tooth without projecting out from the play end of the ring gear section.

15. A method for manufacturing a drive plate comprising:
integrally forming by press working a plate section connected to a crankshaft of an engine, and an annular ring gear section that extends in an axial direction from an outer circumference of the plate section and includes a plurality of external teeth that meshes with a drive gear of a motor for cranking the engine, wherein
each of a plurality of inner side recesses is formed on an inner circumferential surface of the ring gear section so as to be located on an inner side of each of the plurality of external teeth at least on a play end side of the ring gear section, and a step portion recessed toward an inner side than a tooth tip on the play end side is formed in each of the plurality of external teeth.

16. The method for manufacturing the drive plate according to claim 15, further comprising:
compressing an annular wall portion formed in a work using a compression punch, with a constraining punch disposed on an inner side of the annular wall portion and a dice section disposed on an outer side of the annular wall portion; wherein
the constraining punch includes a plurality of projections that projects out in a radial direction at least on a play end side of the annular wall portion; and
the compression punch includes a plurality of protrusions that projects out toward the dice section.
